(19) United States
(12) Patent Application Publication
(10) Pub. No.: US 2026/0219864 A1
(43) Pub. Date: Jul. 30, 2026

(54) Processor Environment Agnostic Firmware Management Operation Including a Device Specific Firmware Management Operation

(71) Applicant: Dell Products L.P., Round Rock, TX (US)

(72) Inventors: Gowrishankar Rudraprakash, Bengaluru (IN); Shekar Babu Suryanarayana, Bangalore (IN); Karunakar Poosapalli, Telangana (IN)

(21) Appl. No.: 19/038,060

(22) Filed: Jan. 27, 2025

(51) Int. Cl. G06F 8/65

(52) U.S. Cl. CPC G06F 8/65

(57) ABSTRACT

A firmware management operation. The firmware management operation includes providing an information handling system with a distributed unified BIOS; identifying a processor environment installed on an information handling system from a plurality of processor environments, the processor environment comprising a processor architecture; and, performing a device specific firmware management operation, the device specific firmware management operation managing update of a device specific component of the distributed unified BIOS.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed unified BIOS; identifying a processor environment installed on an information handling system from a plurality of processor environments, the processor environment comprising a processor architecture; and, performing a device specific firmware management operation, the device specific firmware management operation managing update of a device specific component of the distributed unified BIOS.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed unified BIOS; identifying a processor environment installed on an information handling system from a plurality of processor environments, the processor environment comprising a processor architecture; and, performing a device specific firmware management operation, the device specific firmware management operation managing update of a device specific component of the distributed unified BIOS.

In another embodiment the invention relates to a computer-readable storage medium embodying computer program code, the computer program code comprising computer executable instructions configured for: providing an information handling system with a distributed unified BIOS; identifying a processor environment installed on an information handling system from a plurality of processor environments, the processor environment comprising a processor architecture; and, performing a device specific firmware management operation, the device specific firmware management operation managing update of a device specific component of the distributed unified BIOS.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIG. 5 is a simplified block diagram of Authenticated Basic Input/Output System (BIOS) Interface services implemented within a cloud computing environment;

FIG. 6 is a simplified block diagram showing the performance of certain device specific firmware management operations.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the present disclosure reflect an appreciation that many known important driver updates at runtime need a reboot to update drivers at the same time there are mandatory BIOS updates available on the system which also need to be prioritized and often require an additional reboot. Various aspects of the present disclosure reflect an appreciation that dependencies between firmware updates and runtime driver updates are important for maintaining a stable and functional system. Various aspects of the present disclosure reflect an appreciation that ensuring compatibility between firmware updates and runtime driver updates is important to avoiding system issues.

Various aspects of the present disclosure reflect an appreciation that when a third-party controller or device driver needs to be updated, this update often requires a particular firmware version to be updated after which the third-party controller or device driver can be updated in a next immediate boot driver update. Such a sequence of updates often needs two system reboots to complete the updates. Sometimes the sequence of updates can require more reboots due to dependencies of other driver or third-party vendor firmware. Various aspects of the present disclosure reflect an appreciation that it would be desirable to provide an intelligent method to dynamically learn all update dependencies and update firmware and drivers for the boot path in single reboot.

Various aspects of the present disclosure reflect an appreciation that firmware update and runtime device update dependency can present challenges and potentially lead to firmware corruption issues. For example, skipping or avoiding any one payload update can lead to system or operating system corruption and can potentially lead to no power on self test (POST) scenarios. Various aspects of the present disclosure reflect an appreciation that it would be desirable to provide a firmware solution to handle device firmware updates and pre-boot firmware updates in single reboot.

Various aspects of the present disclosure reflect an appreciation that with certain known systems, there is an in plane switching (IPS) issue where an operating system driver update is dependent on a particular firmware version and the firmware has a dependency on a configuration data set which can be updated only with an operating system driver which is missing on the platform. Various aspects of the present disclosure reflect an appreciation that it would be desirable to provide a firmware solution which includes a device and firmware specific method to dynamically resolve these dependency issues and enable firmware and driver update in single boot.

A system and method are disclosed for performing a device specific firmware management operation. In certain embodiments, the device specific firmware management operation includes an advanced dependence state machine (ADSM) method. In certain embodiments, the ADSM method uses an advanced dependence state machine to dynamically generate operating system runtime drivers which address firmware dependency for update and recover path.

In certain embodiments, the device specific firmware management operation includes creating device specific methods (DSM) and firmware specific methods (FSM) to dynamically enumerate an update environment for advisor at an operating system handoff state. In certain embodiments, the device specific firmware management operation includes creating device specific methods and firmware specific methods to enable firmware and driver update in single reboot. In certain embodiments, the device specific methods and firmware specific methods establish a secure memory interface between a pre-boot phase of operation and an operating system runtime phase of operation. In certain embodiments, the device specific firmware management operation resolves firmware and operating system coupled driver dependencies and issues.

In certain embodiments, the device specific firmware management operation dynamically generates operating system runtime drivers to firmware dependency for update in the same system boot. In certain embodiments, the device specific firmware management operation saves an additional reboot by using the advanced dependence state machine.

For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

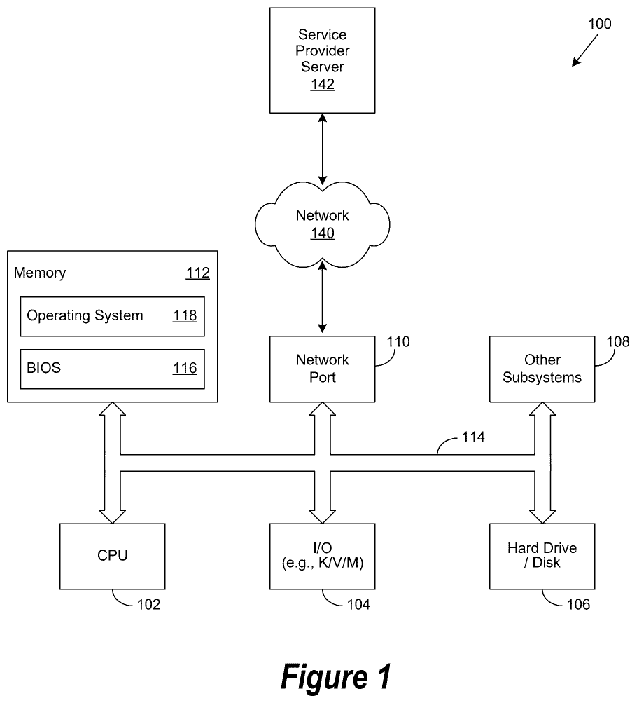

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS's 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS's 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS's 100 initialization and startup within an .efi file, rather than on its associated firmware. In typical implementations, the .efi file may be stored on a special memory partition known as an EFI System Partition (ESP), which also contains the IHS's 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein. In certain embodiments, the distributed BIOS 116 may be implemented as a distributed unified BIOS. As used herein, a distributed unified BIOS 116 broadly refers to a BIOS 116 that includes a plurality of BIOS 116 components, or a plurality of BIOS 116 variables, or a plurality of BIOS 116 storage locations, or a combination thereof, which are implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In various embodiments, the firmware management operation may be implemented to include the performance of a device specific firmware management operation. In certain embodiments, the firmware management operation may be performed during operation of an IHS 100. In various embodiments, performance of the firmware management operation may result in the realization of improved operation of an IHS 100.

A device specific firmware management (DSFM) operation, as used herein, broadly refers to any function, task, procedure, or process performed, directly or indirectly, within a multi-processor operating environment, or an architecture-specific distributed firmware management platform (ASDFMP), both of which are described in greater detail herein, to generate, instantiate, secure, distribute, provision, authenticate, implement, modify, update, replace, monitor, or manage, or a combination thereof, a device specific firmware component. In various embodiments, one or more DSFM operations may be performed to update a particular BIOS 116 component implemented without necessitating the update of other BIOS 116 components.

In certain embodiments, the device specific firmware management operation includes an advanced dependence state machine (ADSM) method. In certain embodiments, the ADSM method uses an advanced dependence state machine to dynamically generate operating system runtime drivers which address firmware dependency for update and recover path.

In certain embodiments, the device specific firmware management operation includes creating device specific methods (DSM) and firmware specific methods (FSM) to dynamically enumerate the update environment for advisor at an operating system handoff state. In certain embodiments, the device specific firmware management operation includes creating device specific methods and firmware specific methods to enable firmware and driver update in single reboot. In certain embodiments, the device specific methods and firmware specific methods establish a secure memory interface between a pre-boot phase of operation and an operating system runtime phase of operation. In certain embodiments, the device specific firmware management operation resolves firmware and operating system coupled driver dependencies and issues.

In certain embodiments, the device specific firmware management operation dynamically generates operating system runtime drivers to firmware dependency for update in the same system boot. In certain embodiments, the device specific firmware management operation which saves an additional reboot by using the advanced dependence state machine.

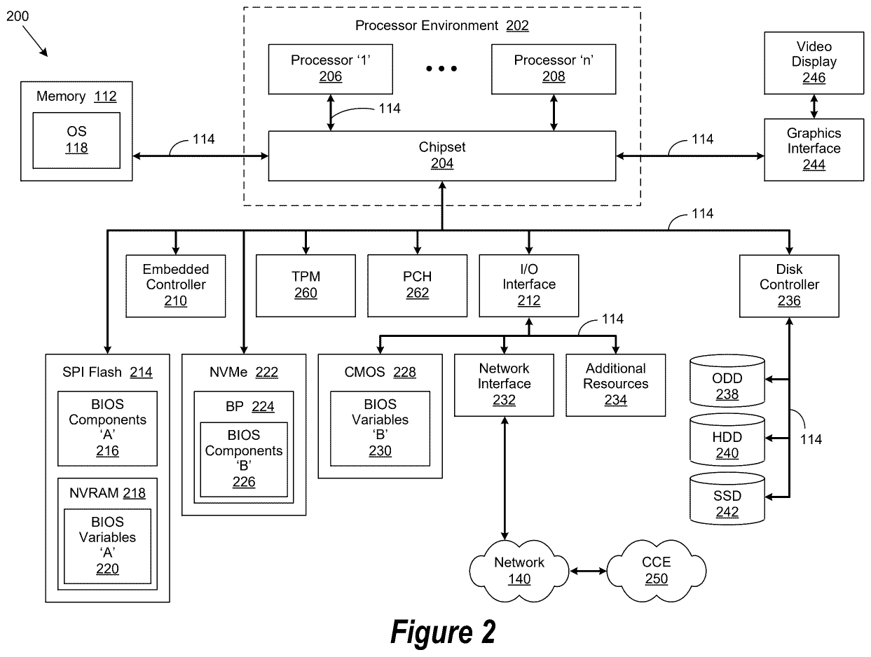

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as an information handling system (IHS), described in greater detail herein, such as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an Advanced Reduced Instruction Set Computer (RISC) Machines (ARM) type processor architecture, or a combination thereof. In various embodiments, a processor environment implementing an x86 type processor architecture provides an x86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented a Graphics Processing Unit (GPU), familiar to skilled practitioners of the art.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft® Windows®, while processor ‘n’ 208 may be implemented to run a version of Linux®.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

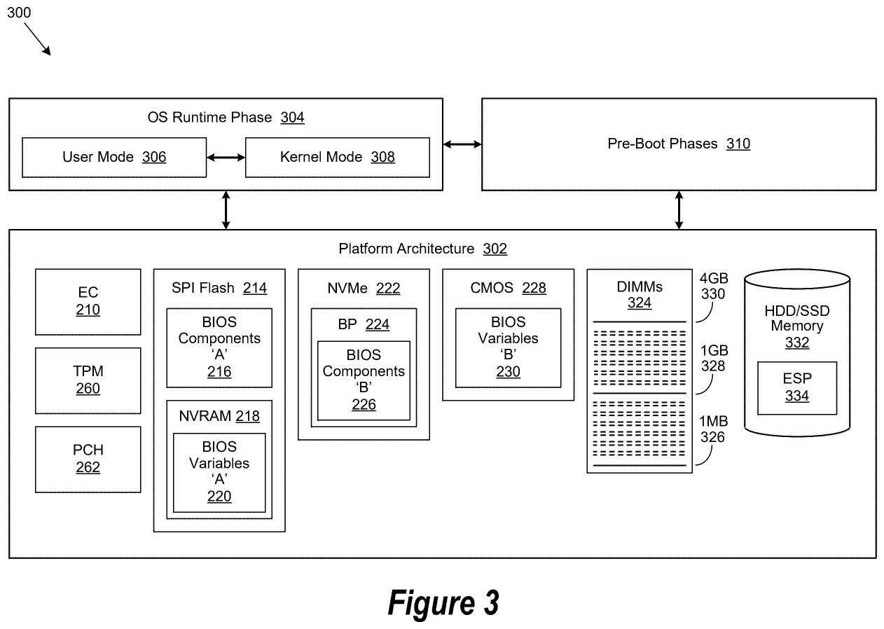

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS's may utilize different processors (e.g., Intel®, AMD®, Qualcom®, Broadcom®, NVidia®, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, each of which may be considered a component of an information handling system (IHS), as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel® to control certain data paths and support functions used in conjunction with Intel® processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel®, AMD®, Qualcomm®, Broadcom®, NVidia®, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1 GB 328 to 4 GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS's that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

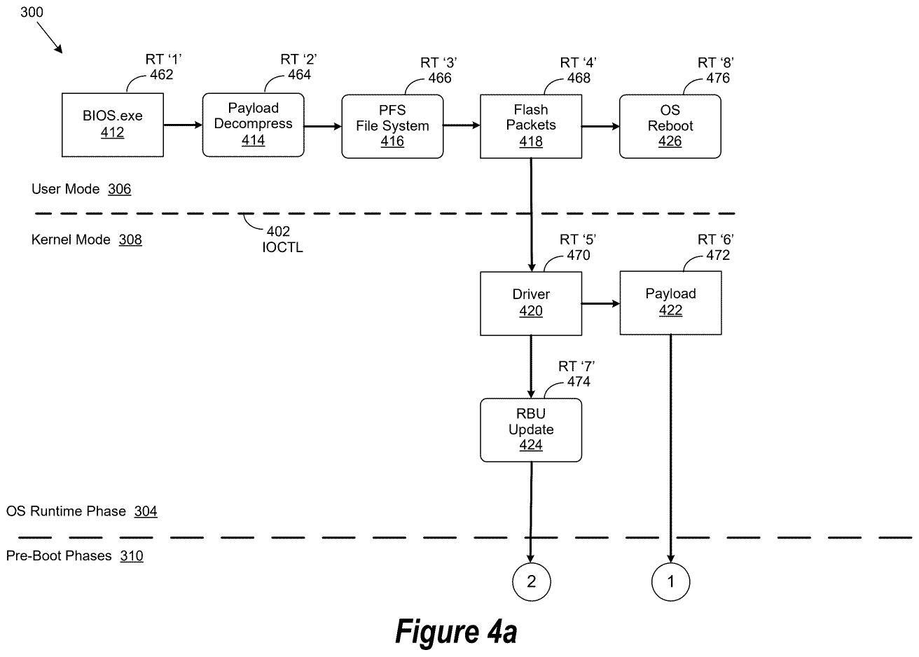

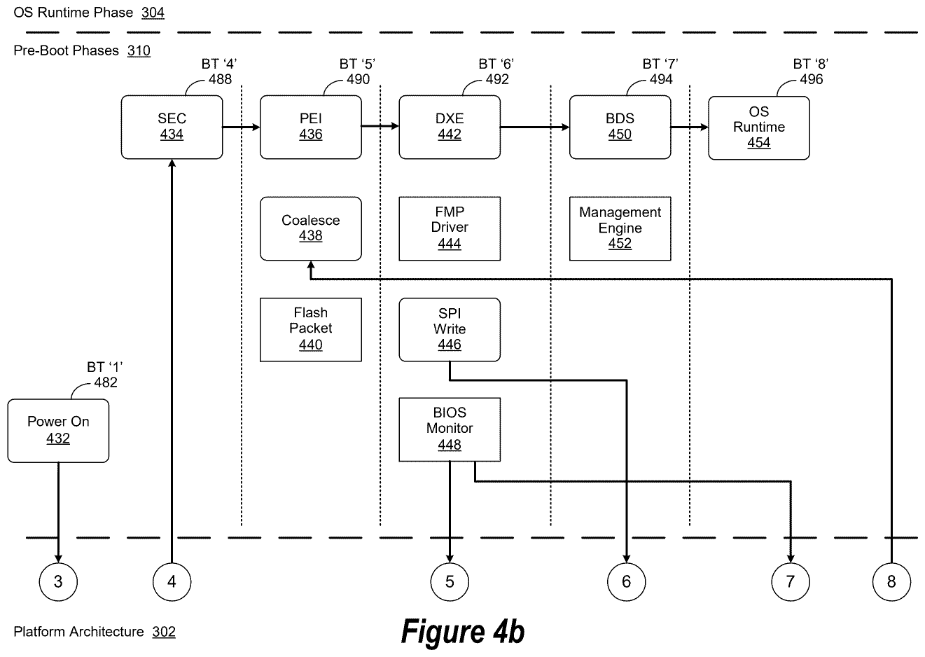

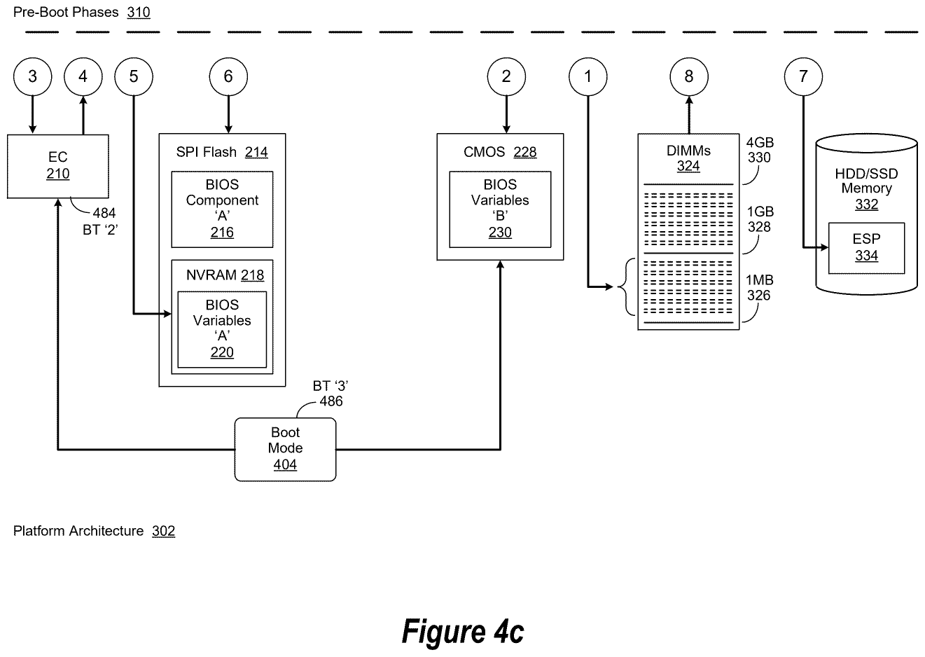

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system's (IHS's) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one or more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6’ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS's processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell® Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel® Corporation of Santa Clara, California, may be implemented to use the selected boot device in BT step ‘8’ 496 to boot the ASDFMP 300 into an OS runtime 454 state.

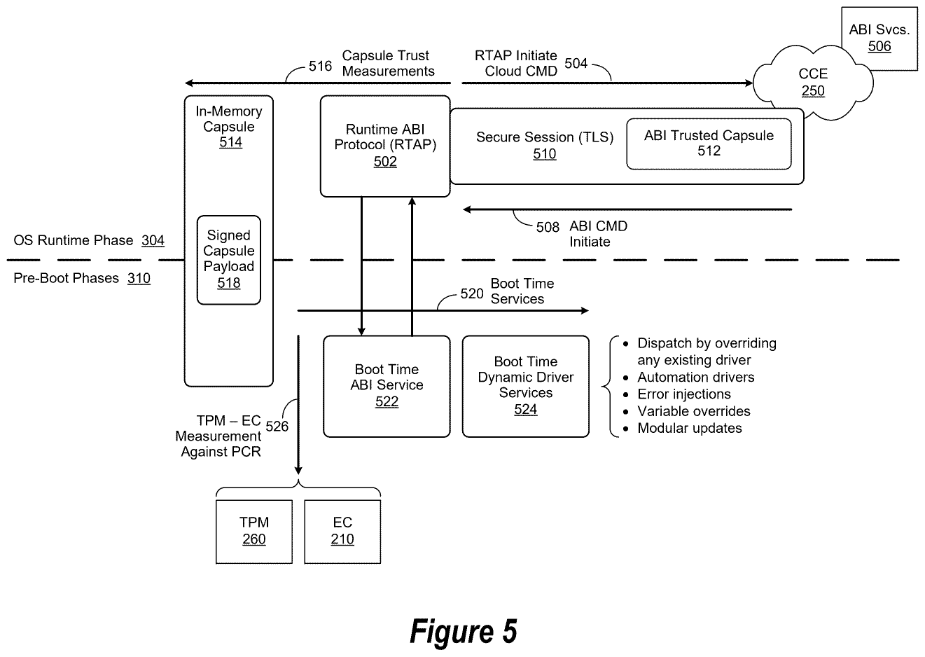

FIG. 5 is a simplified block diagram of Authenticated Basic Input/Output System (BIOS) Interface (ABI) services implemented within a cloud computing environment in accordance with an embodiment of the invention. Various embodiments of the invention reflect an appreciation that running learning models on client devices has become more common as artificial intelligence (AI) evolves. Likewise, various embodiments of the invention reflect an appreciation that large learning models (LLMs) have traditionally been deployed on powerful server infrastructures due to their extensive computational requirements.

However, various embodiments of the invention reflect an appreciation that deploying LLMs on client devices may provide certain advantages, such as a more personalized user experience, faster remediation, more immediate support, more robust data privacy, and so forth. Accordingly, an AI-capable intelligent Basic Input/Output System (BIOS), incorporating advanced algorithms and machine learning capabilities to enhance its functionality, may be implemented in various embodiments. In various embodiments, this intelligent BIOS may be implemented to autonomously detect, diagnose, and remediate issues without human intervention and provide adaptive performance and predictive maintenance.

Likewise, an eXtensible Host Controller Interface (XHCI), described in greater detail herein, may be implemented in various embodiments to improve system speed, power efficiency, and virtualization. Various embodiments of the invention likewise reflect an appreciation that typical storage capacities of portable devices have been increasing over time, with a concomitant need for high performance interfaces so they can be loaded in a reasonable amount of time. Accordingly, the implementation of an xHCI in various embodiments may reduce, or even eliminate, host memory-based transaction schedules, while its support for advanced power management features may likewise provide more power efficient platforms without sacrificing performance.

In various embodiments, the enablement of certain xHCI virtualization features may likewise allow direct assignment of individual Universal Serial Bus (USB) devices to any virtual machine (VM), irrespective of their location within a particular bus topology, to minimize run-time inter-VM communications, and provide support for native USB device sharing, or a combination thereof. Likewise, the implementation of an AI-capable intelligent BIOS in various embodiments may enable support of heterogeneous System on Chip (SoC) vendors, such as Intel®, AMD®, Qualcomm®, NVIDIA®, and so forth. The implementation of an AI-capable intelligent BIOS in various embodiments may likewise enable seamless interdependent updates services for a system's operating system (OS) and firmware. Likewise, the implementation of an intelligent cache in various embodiments may allow one or more Graphics Processing Units (GPUs), Neural Processing Units (NPUs), Accelerated Processing Units (APUs), or a combination thereof, to be leveraged to process AI workloads while supporting host embedded controller (EC) 210 side-band interrupts.

Referring now to FIG. 5, a runtime ABI protocol (RTAP) 502 may be implemented in various embodiments during a system's OS runtime phase 304. In various embodiments, the RTAP 502 may be implemented to initiate an RTAP cloud command (CMD) 504 to access certain ABI services 506, which in certain embodiments may be implemented within a cloud computing environment (CCE) 250, described in greater detail herein. In various embodiments, initiation of the RTAP cloud CMD 504 may result in certain ABI services 506 initiating an ABI CMD 508 in response.

In various embodiments, initiation of the ABI CMD 508 may result in establishing a secure session 510 between the RTAP 502 and the ABI services 506. In various embodiments, the Transport Layer Security (TLS) protocol, familiar to skilled practitioners of the art, may be used to establish the secure session 510 between the RTAP 502 and the ABI services 506. In various embodiments, the secure session 510 may be implemented to allow the ABI services 506 to provide an ABI trusted capsule 512 to the RTAP 502.

In various embodiments, the RTAP 502 may be implemented to load the ABI trusted capsule 512 into system memory as an in-memory capsule 514. In various embodiments, the RTAP 502 may likewise be implemented to perform certain capsule trust measurements 516. Likewise, the RTAP 502 may be implemented in various embodiments to generate a digitally-signed capsule payload 518.

In various embodiments, the RTAP 502 may be implemented to use the contents of the digitally-signed capsule payload 518 to create certain boot time services 520 for use during various pre-boot phases 310. In various embodiments, the boot time services 520 may include a boot time ABI service 522 and one or more boot time dynamic driver services 524. In various embodiments, the boot time ABI service 522 may be implemented to perform certain Trusted Platform Module (TPM) 260 and Embedded Controller (EC) 210 comparisons and measurements 526 against the system's Platform Configuration Register (PCR). In various embodiments the one or more boot time dynamic driver services 524 may be implemented to provide various functionalities, such as performing a dispatch by overriding any existing driver, initiating one or more automation drivers, initiating one or more error injections, performing one or more variable overrides, performing one or more modular updates, and so forth.

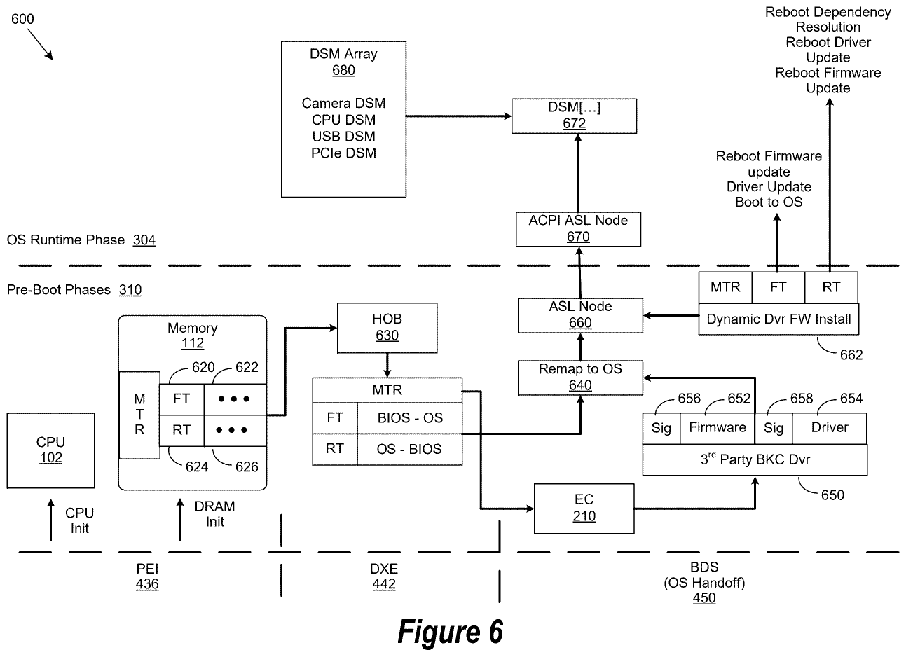

FIG. 6 is a simplified block diagram showing the performance of a device specific firmware management operation 600. In certain embodiments, the device specific firmware management operation 600 includes an advanced dependence state machine (ADSM) method. In certain embodiments, the ADSM method uses an advanced dependence state machine to dynamically generate operating system runtime drivers which address firmware dependency for update and recover path.

In certain embodiments, the device specific firmware management operation 600 includes creating device specific methods (DSM) and firmware specific methods (FSM) to dynamically enumerate the update environment for advisor at an operating system handoff state. In certain embodiments, the device specific firmware management operation 600 includes creating device specific methods and firmware specific methods to enable firmware and driver update in single reboot. In certain embodiments, the device specific methods and firmware specific methods establish a secure memory interface between the pre-boot phase of operation 310 and the operating system runtime phase of operation 304. In certain embodiments, the device specific firmware management operation 600 resolves firmware and operating system coupled driver dependencies and issues.

In certain embodiments, the device specific firmware management operation 600 dynamically generates operating system runtime drivers to firmware dependency for update in the same system boot. In certain embodiments, the device specific firmware management operation 600 saves an additional reboot by using the advanced dependence state machine.

In certain embodiments, the device specific firmware management operation 600 conforms to operating system notification requirements. In certain embodiments, the device specific firmware management operation 600 conforms to operating system notification requirements by maintaining an uncharged push notification for the operating system, as the device specific firmware management operation 600 does not use or require an operating system driver.

In certain embodiments, the device specific firmware management operation 600 initializes a central processing unit 102 during a PEI phase 436 of a pre-boot phase 310. In certain embodiments, the device specific firmware management operation 600 initializes the central processing unit 102 via a CPU Init operation. In certain embodiments, the central processing unit 102 is associated with a particular processor environment (PE) 202. Next, the device specific firmware management operation 600 initializes a memory 112 during the PEI phase 436 of a pre-boot phase 310. In certain embodiments, the memory 112 includes one or more DIMMs 324. In certain embodiments, the device specific firmware management operation 600 initializes the memory 112 via a DRAM Init operation. In certain embodiments, initializing the memory 112 includes initializing a memory transaction region (MTR) within the memory 112. In certain embodiments, the memory transaction region is stored within a low memory region of memory, as described herein. In certain embodiments, a forward translation component 620 is stored within the memory transaction region. In certain embodiments, the forward translation component 620 includes associated forward translation information 622. In certain embodiments, the associated forward translation information 622 includes information associated with translating update content from BIOS to operating system. In certain embodiments, a reverse translation component 624 is stored within the memory transaction region. In certain embodiments, the reverse translation component 624 includes associated reverse translation information 626. In certain embodiments, the associated reverse translation information 626 includes information associated with translating update content from operating system to BIOS.

Next, the device specific firmware management operation 600 accesses a hand off block 630 to progress from the PEI phase 436 to the DXE phase 442. In certain embodiments, the hand off block 630 generates memory mapped device specific methods. In certain embodiments, the memory mapped device specific methods include the forward translation component, the associated forward translation information, the reverse translation component, the associated reverse translation information, or a combination thereof. In certain embodiments, the memory mapped device specific methods are provided to the embedded controller 210. In certain embodiments, the memory mapped device specific methods are remapped to operating system components during a BDS phase 450 (also referred to as an operating system handoff phase) at step 640.

In certain embodiments, the embedded controller 210 provides a root of trust that is applied to any device best known configuration drivers 650. In certain embodiments, the best known configuration drivers include associated firmware components 652 and operating system driver components 654. In certain embodiments, the associated firmware components 652 includes a respective firmware component signature 656. In certain embodiments, the associated operating system driver components 654 includes a respective operating system component signature 658. In certain embodiments, the firmware components 652, the operating system driver components 654, or a combination thereof, are remapped to operating system components during a BDS phase 450 at step 640. In certain embodiments, the remapped operating system components are provided to an ASL node 660. In certain embodiments, the ASL node 660 also receives the memory mapped device specific methods include the forward translation component, the associated forward translation information, the reverse translation component, the associated reverse translation information, or a combination thereof, from the memory transaction region. In certain embodiments, the memory mapped device specific methods are used by the device specific firmware management operation 600 to generate dynamic driver firmware installation components 662. In certain embodiments, the dynamic driver firmware installation components 662 are provided to the ASL node 660.

In certain embodiments, the ASL node 660 performs an operating system runtime phase handoff via an ACPI ASL node 670. In certain embodiments, the ACPI ASL node 670 provides perform a trusted update of a driver in the operating system handoff path. In certain embodiments, the ACPI ASL node 670 accesses a device specific methods module 672 when updating the operating system drivers

In certain embodiments, the device specific firmware management operation 600 interacts with and manages third party vendor device drivers which have an equivalent vendor provided firmware. The payload comes as single package with an embedded third-party signature in it, so the device specific firmware management operation 600 leverages the same signature to perform a trusted update of firmware in pre-boot path and trusted update of a driver in the operating system handoff path using the ACPI ASL node 670. In certain embodiments, the device specific firmware management operation 600 uses the embedded controller 210 to provide a root of trust for the third-party driver update.

In certain embodiments, with the device specific firmware management operation 600 when a driver update is blocked due to an operating system vulnerability or dependent firmware version, the device specific firmware management operation 600 dynamically identifies the dependency and vulnerability path and performs a memory forward translation (MFT) operation. As used herein, a memory forward translation operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, one or more operating system runtime drivers, or a combination thereof, to dynamically enumerate an update environment.

In certain embodiments, the memory forward transformation adds dependent firmware payloads for update and corresponding driver update during the operating system handoff phase. In certain embodiments, the memory forward transformation adds a dependent firmware payload for update and corresponding driver update before a vulnerable path can be opened to block driver updates. In certain embodiments, the memory forward translation uses a memory forward translation protocol (MFT protocol) In certain embodiments, the memory forward protocol enables driver update even when an operating system driver update path is blocked due to vulnerability or firmware dependency. As used herein, a memory forward translation protocol broadly refers to a set of rules for formatting and processing data associated with performance of a memory forward translation operation, described in greater detail herein. In certain embodiments, the memory forward translation operation dynamically enables driver update even when an operating system driver update path is blocked due to vulnerability or firmware dependency.

In certain embodiments, for a scenario where third-party firmware requires a driver to update an attribute in BIOS and attribute update is blocked due to an operating system vulnerability, the memory reverse translation (MRT) operation is performed. As used herein, a memory reverse translation operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, one or more operating system runtime drivers, or a combination thereof, to change a reboot path after a shutdown event from the operating system, thereby allowing a firmware update followed by driver update.

In certain embodiments, the memory reverse translation operation allows a driver to change a BIOS attribute in reboot path after a shutdown event from the operating system, thereby allowing a firmware update followed by driver update. In certain embodiments, the memory reverse translation uses a memory reverse translation protocol (MRT protocol). As used herein, a memory reverse translation protocol broadly refers to refers to a set of rules for formatting and processing data associated with performance of a memory reverse translation operation, described in greater detail herein.

In certain embodiments, the device specific firmware management operation 600 protects update payloads from middle attacks to prevent tampering with the update payloads. More specifically, middle attacks are not possible with the device specific firmware management operation 600 as the memory forward translation protocol and the memory reverse translation protocol operates in a reboot path (as compared with operating as operating system runtime). Additionally, the operating system root for the third-party vendor code is extended via the root of trust provided by the embedded controller 210.

In certain embodiments, the device specific firmware management operation 600 obtains a trust factor from the Advanced Configuration and Power Interface (ACPI) ACPI source language (ASL) node 670. The ACPI ASL node 670, in combination with the embedded controller 210, provides the root of trust for the third-party driver signatures. In certain embodiments, the same signatures are shared with the firmware component and the corresponding driver from the third-party vendor. Accordingly, the device specific firmware management operation 600 is distinct from operation system reboot notifications and coexists with known operating system reboot notifications.

In certain embodiments, the device specific firmware management operation 600 interacts with an already present ASL node for an operating system pending reboot notification and operates unchanged in handling any pending reboot notifications. In certain embodiments, the device specific firmware management operation 600 addresses the issue of there being no solutions available to provide firmware and runtime drivers update in same system boot. With the device specific firmware management operation 600, a single pending reboot notification tray is updated with firmware and driver update in single reboot path.

In certain embodiments, with the device specific firmware management operation 600, the operating system driver update policy is unaltered. In certain embodiments, the operating system driver update policy is unaltered because the driver update happens with in operating system handoff phase and the notification is managed by the ASL node itself.

In certain embodiments, the device specific firmware management operation 600 provides protection against tampering. In certain embodiments, the payload carrying the third-party vendor firmware and driver is pushed into a low memory region, as described herein. In certain embodiments, the payload carrying the third-party vendor firmware and driver is pushed into a 1 MB to 1 GB ring zero memory (as an enclave). Accordingly, only a supplier specific firmware update tool can perform this update. In certain embodiments, by storing the payload within the memory as an enclave, no third-party code can access the payload, thus preventing any external snooping. In certain embodiments, the forward translation method and the reverse translation method ensure firmware and driver is presented to BIOS for update, thus ensuring a secure update.

In certain embodiments, the device specific firmware management operation 600 uses the advanced dependence state machine to resolve any dependency of BIOS and firmware drivers. In certain embodiments, a best known configuration (BKC) device discovery protocol running in pre-boot and ACPI ASL node at operating system runtime synchronizes a dependency list and maintains updates via an update and recovery state machine. As used herein, a BKC device discover protocol broadly refers to broadly refers to a set of rules for formatting and processing data associated with performance of a BKC device discover operation, described in greater detail herein. As used herein, a BKC device discover operation broadly refers to a firmware management operation, described in greater detail herein, performed directly, or indirectly, within a multi-processor operating environment 200 to store, retrieve, aggregate, disaggregate, add, delete, modify, revise, update, replace, or restore best known configuration information associated with one or more devices of the information handling system, including third party devices. In certain embodiments, the best known configuration device discovery operation synchronizes a device specific component dependency list and maintaining device specific component updates. In certain embodiments, the platform firmware dependent drivers (i.e., BKC model drivers) are supported by the device specific firmware management operation 600, while operating system vendor specific drivers or system drivers are not supported.

As will be appreciated, the device specific firmware management operation 600 is distinct from an operating system vendor pending reboot notification feature which helps users stay informed about system reboots required by updates. As will be appreciated, the device specific firmware management operation 600 addresses a need for an update solution which provides firmware and runtime drivers update in same system boot.

In certain embodiments, the device specific firmware management operation 600 dynamically generates the advanced dependence state machine for operating system runtime drivers. In certain embodiments, the device specific firmware management operation 600 uses machine learning when dynamically generating the advanced dependence state machine for operating system runtime drivers. In certain embodiments, the advanced dependence state machine resolves firmware dependency and enables the firmware boot path to update these drivers on recovery or update path.

In certain embodiments, the device specific methods are registered in accordance with the operating system vendor defined methods. In certain embodiments, the device specific firmware management operation 600 performs a firmware-level handoff, where operating system initialization is triggered following the firmware-level handoff. In certain embodiments, the operating system accesses a DSM array 680. In certain embodiments, the DSM array 680 maintains device specific DSM information. For example, the device specific information can include camera specific DSM information, CPU specific DSM information, USB specific DSM information, PCIe specific DSM information, etc. In certain embodiments, the DSM array 680 exposes all object layer interfaces and service layer interfaces to the operating system, enabling interaction through these interfaces. In certain embodiments, the DSM information is provided to a DSM module 672 during the operating system runtime phase 304. In certain embodiments, the DSM module 672 interacts with the ACPI ASL node 670. In certain embodiments, the ACPI ASL node 670 is exposed within the operating system during the firmware to operating system handoff and operating system initialization phases. During firmware handoff, a runtime hand off block (HOB) 630 is created. In certain embodiments, the HOB contains memory-mapped DSM methods. In certain embodiments, the memory-mapped DSM methods provide an object for each hardware component, firmware module, and operating system level driver. In certain embodiments, the operating system level drivers include device-specific drivers which ensure proper communication and initialization at the operating system level.

In certain embodiments, each device-specific driver coexists with the devices across different states of the information handling system. In certain embodiments, the device-specific drivers coexist with the devices across a modern standby operating state, an ACPI sleep state (S3) resume operating state, an operating system boot power-on operating state, or a combination thereof. In certain embodiments, the DSM provides a standardized approach where a unified surface is applied during operating system handoff and operating system initialization. In certain embodiments, each device includes an associated device-specific DSM method. In certain embodiments, each device-specific DSM method includes all relevant objects and exposes all relevant services associated with the device. In certain embodiments, the relevant services can include either runtime services or boot-time services. In certain embodiments, the boot-time services influence firmware updates, while the runtime services handle driver installation notifications.

In certain embodiments, a known operating system device driver update layer operates using similar runtime services, which follow similar principle. In certain embodiments, the objects are staged within the pipeline through the DSM methods. So staging the objects allows for device updates during the operating system runtime or at operating system handoff. By defining these services, the device specific firmware management operation 600 enables updates to be processed before operating system standby, thus optimizing the update process.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed unified BIOS;
identifying a processor environment installed on an information handling system from a plurality of processor environments, the processor environment comprising a processor architecture; and,
performing a device specific firmware management operation, the device specific firmware management operation managing update of a device specific component of the distributed unified BIOS.

2. The method of claim 1, wherein:
the device specific firmware management operation uses an advanced dependence state machine, the advanced dependence state machine resolving dependency of BIOS and firmware drivers.

3. The method of claim 1, wherein:
the device specific firmware management operation performs a best known configuration device discovery operation, the best known configuration device discovery operation synchronizing a device specific component dependency list and maintaining device specific component updates.

4. The method of claim 1, wherein:
the device specific firmware management operation uses a device specific method and a firmware specific method.

5. The method of claim 4, wherein:
the device specific firmware management operation creating the device specific method and the firmware specific method; and,
the device specific method and the firmware specific method enable firmware and driver update in single reboot.

6. The method of claim 5, wherein:
the device specific method and the firmware specific method establish a secure memory interface between a pre-boot phase of operation and an operating system runtime phase of operation.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed unified BIOS;
identifying a processor environment installed on an information handling system from a plurality of processor environments, the processor environment comprising a processor architecture; and,
performing a device specific firmware management operation, the device specific firmware management operation managing update of a device specific component of the distributed unified BIOS.

8. The system of claim 7, wherein:
the device specific firmware management operation uses an advanced dependence state machine, the advanced dependence state machine resolving dependency of BIOS and firmware drivers.

9. The system of claim 7, wherein:
the device specific firmware management operation performs a best known configuration device discovery operation, the best known configuration device discovery operation synchronizing a device specific component dependency list and maintaining device specific component updates.

10. The system of claim 7, wherein:
the device specific firmware management operation uses a device specific method and a firmware specific method.

11. The system of claim 10, wherein:
the device specific firmware management operation creating the device specific method and the firmware specific method; and,
the device specific method and the firmware specific method enable firmware and driver update in single reboot.

12. The system of claim 11, wherein:
the device specific method and the firmware specific method establish a secure memory interface between a pre-boot phase of operation and an operating system runtime phase of operation.

13. A non-transitory, computer-readable storage medium embodying computer program code, the computer program code comprising computer executable instructions configured for:
providing an information handling system with a distributed unified BIOS;
identifying a processor environment installed on an information handling system from a plurality of processor environments, the processor environment comprising a processor architecture; and,
performing a device specific firmware management operation, the device specific firmware management operation managing update of a device specific component of the distributed unified BIOS.

14. The non-transitory, computer-readable storage medium of claim 13, wherein:
the device specific firmware management operation uses an advanced dependence state machine, the advanced dependence state machine resolving dependency of BIOS and firmware drivers.

15. The non-transitory, computer-readable storage medium of claim 13, wherein:
the device specific firmware management operation performs a best known configuration device discovery operation, the best known configuration device discovery operation synchronizing a device specific component dependency list and maintaining device specific component updates.

16. The non-transitory, computer-readable storage medium of claim 13, wherein:
the device specific firmware management operation uses a device specific method and a firmware specific method.

17. The non-transitory, computer-readable storage medium of claim 16, wherein:
the device specific firmware management operation creating the device specific method and the firmware specific method; and,
the device specific method and the firmware specific method enable firmware and driver update in single reboot.

18. The non-transitory, computer-readable storage medium of claim 17, wherein:
the device specific method and the firmware specific method establish a secure memory interface between a pre-boot phase of operation and an operating system runtime phase of operation.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
